(19) United States
(12) Patent Application Publication
(10) Pub. No.: US 2020/0171912 A1
(43) Pub. Date: Jun. 4, 2020

(54) HEAD-UP DISPLAY

(71) Applicant: DENSO CORPORATION, Kariya-city (JP)

(72) Inventors: Hirohisa MOTOMURA, Kariya-city (JP); Keisei HARA, Kariya-city (JP); Taizo MIYATO, Kariya-city (JP); Yasuhiko NIIMI, Kariya-city (JP)

(21) Appl. No.: 16/780,544

(22) Filed: Feb. 3, 2020

Related U.S. Application Data
(63) Continuation of application No. PCT/JP2018/029651, filed on Aug. 7, 2018.

(30) Foreign Application Priority Data
Aug. 8, 2017 (JP) 2017-153384
May 22, 2018 (JP) 2018-098072

(51) Int. Cl. B60H 1/00; B60K 37/02; G02B 27/01

(52) U.S. Cl. CPC B60H 1/00271; B60K 37/02; B60H 2001/003; B60K 2370/70; G02B 27/0149

(57) ABSTRACT

A head-up display is applied for a moving body that includes a windshield, an air-conditioning unit having a blow-out opening, and a blow-out outlet. The head-up display includes a light source that emits display light and an optical path housing that defines therein an optical path for the display light. The display light reaches the windshield and the information is displayed on the windshield. The head-up display further includes an air-conditioning duct that defines an air flow path. The light source is exposed to the air flow path and radiates heat in the air flow path. The optical path housing and the air-conditioning duct commonly includes a separation wall that separates the air flow path and the optical path.

### CROSS REFERENCE TO RELATED APPLICATIONS

This application is a continuation application of international Patent Application No. PCT/JP2018/029651 filed on Aug. 7, 2018, which designated the U.S. and claims the benefit of priority from Japanese Patent Application No. 2017-153384 filed on Aug. 8, 2017 and Japanese Patent Application No. 2018-098072 filed on May 22, 2018. The entire disclosure of all of the above applications are incorporated herein by reference.

### TECHNICAL FIELD

The present disclosure relates to a head-up display.

### BACKGROUND ART

There has been a head-up display for automobiles (hereinafter referred to as “HUD”) that cools heat radiating components of the HUD by an air flow in an air-conditioning duct. Such an air-conditioning duct defines a ventilation path along which an air flow blown from a vehicle air-conditioning unit flows and first and second branch flow paths that divide the air flow in the ventilation path.

### SUMMARY

One aspect of the present disclosure is a head-up display for a moving body that includes a windshield, an air-conditioning unit having a blow-out opening through which an air flow is blown out, and a blow-out outlet through which the air flow from the blow-out opening is blown out. The head-up display includes a light source that emits display light for displaying information and an optical path housing that defines therein an optical path for the display light to travel from the light source to the windshield. The display light that has passed through the optical path reaches the windshield and the information is displayed on the windshield. The head-up display further includes an air-conditioning duct that defines an air flow path along which the air flow from the blow-out opening flows to the blow-out outlet. The light source is exposed to the air flow path of the air-conditioning duct and radiates heat in the air flow path. The optical path housing and the air-conditioning duct commonly includes a separation wall that separates the air flow path and the optical path. The optical path housing and the air-conditioning duct are integrally formed with each other.

### BRIEF DESCRIPTION OF DRAWINGS

The above and other objects, features and advantages of the present disclosure will become more apparent from the following detailed description made with reference to the accompanying drawings.

FIG. 1 is a cross-sectional view of an internal configuration of a vehicle HUD according to a first embodiment viewed along a vehicle width direction.

FIG. 2 is a schematic view of the vehicle HUD and an air-conditioning unit according to the first embodiment viewed through an instrument panel from an upper side.

FIG. 3 is a schematic view of a vehicle HUD and an air-conditioning unit according to a second embodiment viewed through an instrument panel from an upper side.

FIG. 4 is a diagram showing an arrangement relationship between a heat radiating portion and an air-conditioning duct of a light source according to the second embodiment when viewed from the rear side in the vehicle traveling direction.

FIG. 5 shows a positional relationship between the light source and an optical path housing according to the second embodiment when viewed from an upper side.

FIG. 6 is a diagram of the overall configuration of a vehicle according to the second embodiment as viewed from the upper side, and more specifically, is a diagram showing a relationship between the reinforcement and the light source as viewed from the upper side.

FIG. 7 is a diagram illustrating a connection relationship between the air-conditioning ducts according to the second embodiment.

FIG. 8 is a diagram illustrating a connection relationship between air-conditioning ducts according to a modification to the second embodiment.

FIG. 9 is a diagram illustrating a position of a door during a cooling mode according to a third embodiment.

FIG. 10 is a diagram illustrating a position of the door during a heating mode according to the third embodiment.

FIG. 11 is a diagram showing an electrical configuration according to the third embodiment;

FIG. 12 is a flowchart showing a door control process by an electronic control unit according to the third embodiment.

FIG. 13 is a diagram showing a positional relationship between a light source and an optical path housing according to another embodiment.

### DESCRIPTION OF EMBODIMENTS

Hereinafter, embodiments of the present disclosure will be described with reference to the drawings. In the following embodiments, the same or equivalent parts are denoted by the same reference numerals as each other, and explanations will be provided to the same reference numerals for simplifying descriptions.

The inventors of the present disclosure have studied to improve mountability of the air-conditioning duct and the HUD to moving bodies such as a vehicle while maintaining the cooling performance.

One aspect of the present disclosure is a head-up display for a moving body that includes a windshield, an air-conditioning unit having a blow-out opening through which an air flow is blown out, and a blow-out outlet through which the air flow from the blow-out opening is blown out. The head-up display includes a light source that emits display light for displaying information and an optical path housing that defines therein an optical path for the display light to travel from the light source to the windshield. The display light that has passed through the optical path reaches the windshield and the information is displayed on the windshield. The head-up display further includes an air-conditioning duct that defines an air flow path along which the air flow from the blow-out opening flows to the blow-out outlet. The light source is exposed to the air flow path of the air-conditioning duct and radiates heat in the air flow path. The optical path housing and the air-conditioning duct commonly includes a separation wall that separates the air flow path and the optical path. The optical path housing and the air-conditioning duct are integrally formed with each other.

Therefore, since the gap between the optical path housing and the air-conditioning duct can be reduced, the total size of the optical path housing and the air-conditioning duct can be reduced. Therefore, the mountability to a moving body can be improved.

As described above, the light source is exposed to the air flow path of the air-conditioning duct, and the light source radiates heat in the air flow path. Thus, the light source can be effectively cooled.

As a result, it is possible to provide a head-up display that can be mounted in a moving body while maintaining cooling performance.

Another aspect of the present disclosure is a head-up display, in which the light source includes a heat radiating portion that is exposed to the air flow path and radiates heat in the air flow path. A direction along which a mainstream of the air flow flows through the air flow path is defined as an air flow direction. A direction that is orthogonal to the air flow direction is defined an orthogonal direction. The heat radiating portion extends along both the air flow direction and the orthogonal direction. A largest dimension of the heat radiating portion in the air flow direction is defined as a first length. A largest dimension of the heat radiating portion in the orthogonal direction is defined as a second length. The heat radiating portion is formed such that the first length is greater than the second length.

Therefore, as compared with the case where the second length is less than the first length, the heat radiation area of the heat radiating portion can be enlarged.

It should be noted that the mainstream of the air flow means an air flow having the largest air volume among a plurality of air flows in the air flow path.

### First Embodiment

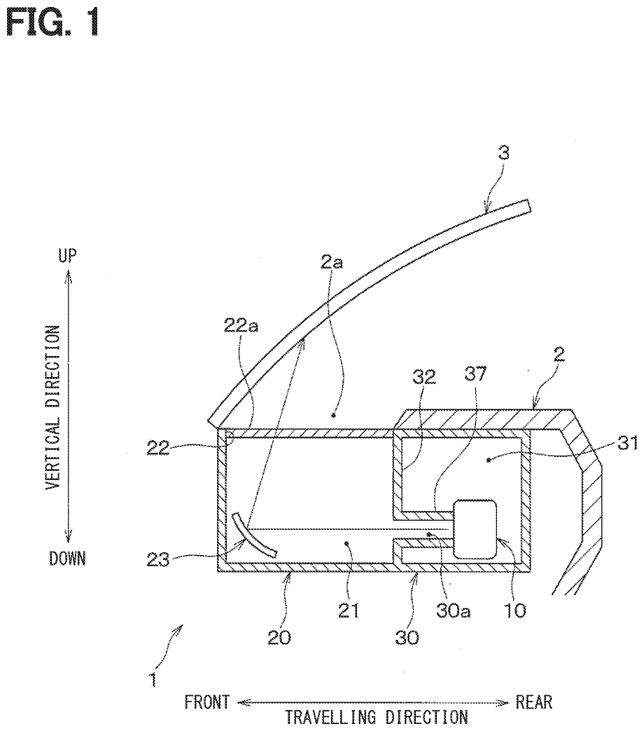

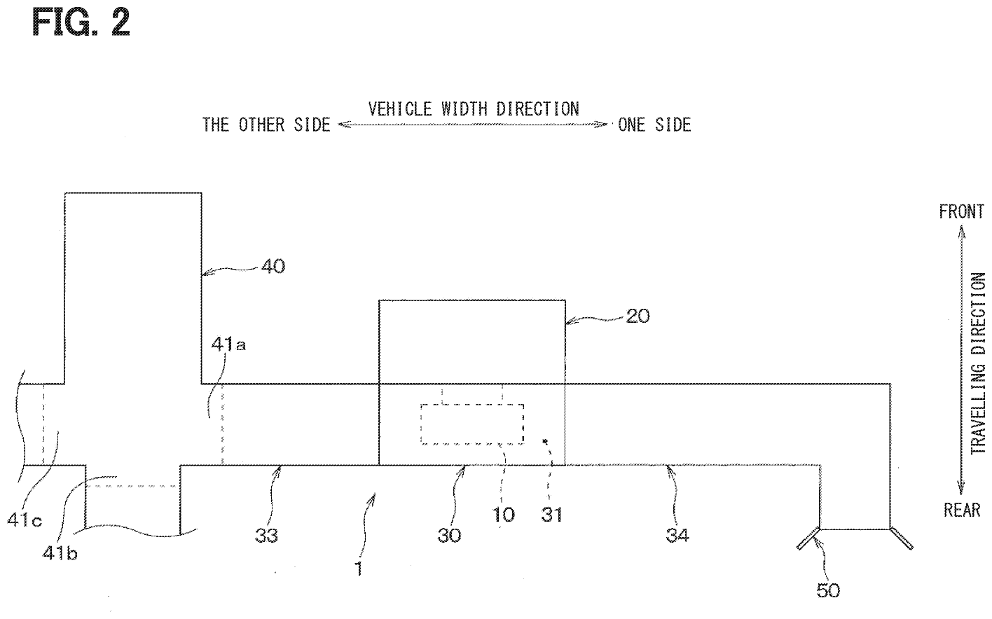

As shown in FIGS. 1 and 2, a vehicle HUD 1 of the present embodiment includes a light source 10, an optical path housing 20, and an air-conditioning duct 30.

The light source 10 constitutes a head-up display together with the optical path housing 20, and emits display light for displaying various information. The light source 10 includes a display unit, a light emitting element, a drive circuit that drives the light emitting element, and the like. The light source 10 is disposed under an instrument panel 2 on a front side of the vehicle interior in the vehicle traveling direction. The light source 10 of the present embodiment is disposed closer to the driver's seat than the center position of the vehicle width direction.

The instrument panel 2 is a panel equipped with various meters for the vehicle. The instrument panel 2 is disposed under the front windshield 3 in the vertical direction and is disposed on the front side of both the driver seat and the passenger seat in the vehicle traveling direction.

The optical path housing 20 is disposed below an opening 2a of the instrument panel 2. The opening 2a of the instrument panel 2 is located under the front windshield 3 in the vertical direction and in front of the light source 10 in the vehicle traveling direction. The optical path housing 20 is made of a light shielding resin material and so on, and defines an optical path 21 and an opening 22. The opening 22 opens toward an inner surface of the front windshield 3 through the opening 2a of the instrument panel 2.

A window 22a made of a transparent material such as a transparent resin is fitted into the opening 22. A reflecting mirror 23 that reflects and guides display light from the light source 10 to the window 22a is disposed in the optical path 21. The window 22a is provided to prevent dust from entering the optical path housing 20.

In the present embodiment, the light source 10 is disposed behind the optical path housing 20 in the vehicle traveling direction. The light source 10 is disposed next to the optical path housing 20.

The air-conditioning duct 30 is disposed under the instrument panel 2 and behind the optical path housing 20 in the vehicle traveling direction. The air-conditioning duct 30 defines an air passage 31 that guides a cold air blown from the blow-out opening 41a of a vehicle air-conditioning unit 40 to a side face outlet 50.

In the present embodiment, the air flow path 31 does not have a branch flow path in the air-conditioning duct 30 that divides the cold air blown from the blowing opening 41a of the vehicle air-conditioning unit 40. In other words, the air-conditioning duct 30 is a duct from which the air flow path 31 does not branch off.

As a result, the air flow path 31 is formed such that all the cold air from the blow-out opening 41a passes through the air flow path 31 in the air-conditioning duct 30. For this reason, the cold air from the blow-out opening 41a flows through the air flow path 31 regardless of whether the light source 10 is on or off.

It should be noted that an air-conditioning duct of a comparative example defines a ventilation path along which an air flow blown from a blow-out opening of an interior air conditioner flows and first and second branch flow paths that divert the air flow in the ventilation path. A heat radiating part of the HUD is cooled by the air flow in the second ventilation path of the first and second flow paths. For this reason, although a portion of the air flow from the blow-out opening flows into the second ventilation path, the entire air flow from the blow-out opening does not flow into the second ventilation path.

The light source 10 is disposed in the air-conditioning duct 30. More specifically, a portion of the light source 10 other than the light emitting portion is surrounded by the air flow path 31. More specifically, a portion of the light source 10 other than the light emitting portion is exposed to the air flow path 31. That is, portions other than the light emitting portion of the light source 10 are exposed in the air flow path 31.

In the air-conditioning duct 30, a light guide path 30a for guiding display light from the light source 10 to the optical path 21 in the optical path housing 20 is formed. The light guide path 30a is defined by a light guide tube 37. The light guide tube 37 is provided between the light emitting portion of the light source 10 and the optical path 21.

The air-conditioning duct 30 and the optical path housing 20 of the present embodiment commonly include a separation wall 32. The separation wall 32 constitutes a wall that separates the air flow path 31 and the optical path 21. The light guide tube 37 is also commonly included by the air-conditioning duct 30 and the optical path housing 20.

Between the air inlet of the air-conditioning duct 30 and the blow-out opening 41a of the vehicle air-conditioning unit 40, an air-conditioning duct 33 is disposed as an upstream duct. The air inlet of the air-conditioning duct 33 is connected to the blow-out opening 41a. The air outlet of the air-conditioning duct 33 is connected to the air inlet of the air-conditioning duct 30.

Between the air outlet of the air-conditioning duct 30 and the side face outlet 50, an air-conditioning duct 34 is disposed as a downstream duct. The air outlet of the air-conditioning duct 30 is connected to an air inlet of the air-conditioning duct 34. An air outlet of the air-conditioning duct 34 is connected to the side face outlet 50. The side face outlet 50 is a blow-out outlet that is disposed on one side of the center position of the instrument panel 2 in the vehicle width direction and blows out cold air toward the upper body of a passenger in the vehicle interior.

Here, the one side in the vehicle width direction means one of the right side and the left side in the vehicle width direction on which the driver's seat is disposed. Thus, if the driver's seat is positioned on the right side in the vehicle width direction, the side face outlet 50 is positioned on the right side of the center position in the vehicle width direction. On the contrary, if the driver's seat is positioned on the left side in the vehicle width direction, the side face outlet 50 is positioned on the left side of the center position in the vehicle width direction.

The optical path housing 20, the air-conditioning duct 30, and the light guide tube 37 of this embodiment are integrally formed with each other using a light shielding resin material. That is, the optical path housing 20 and the air-conditioning duct 30 are formed as an integrally molded product made of a light shielding resin material.

Accordingly, it is possible to prevent the display light from leaking outside from the portion other than the window 22a in the optical path housing 20 or to prevent outside light from entering the optical path housing 20 as a disturbance.

The vehicle air-conditioning unit 40 is a vehicle air-conditioner that introduces inside air or outside air, adjusts the temperature of the introduced air, and blows out the temperature-adjusted air as cold air through a plurality of air outlets including the blow-out opening 41a.

The plurality of air outlets include a face blow-out opening 41b, a side face blow-out opening 41c, a foot blow-out opening (not shown), a defroster blow-out opening (not shown), and the like.

Next, the operation of the vehicle head-up display 1 of this embodiment will be described.

When the light source 10 emits display light, the emitted display light travels to the optical path 21 through the light guide path 30a. This display light travels in the optical path 21. At this time, the display light is reflected by the reflecting mirror 23, and the reflected display light passes through the window 22a and the opening 2a.

Thus, the display light that has passed through the optical path 21, the window 22a, and the opening 2a reaches the front windshield 3. As a result, various information based on the display light is displayed on the front windshield 3. Hence, various information is visually recognized by the driver as virtual images.

At this time, the light source 10 generates heat when emitting the display light. On the other hand, cold air is blown out from the blow-out opening 41a of the vehicle air-conditioning unit 40. This cold air is blown out from the side face outlet 50 into the vehicle interior through the air-conditioning ducts 33, 30, 34.

As described above, the portions other than the light emitting portion of the light source 10 are exposed to the air flow path 31 of the air-conditioning duct 30. Thus, the light source 10 radiates heat to the cold air in the air flow path 31. Thereby, the light source 10 is cooled by the cold air.

According to this embodiment described above, the vehicle HUD 1 is applied to a vehicle having the front windshield 3, the air-conditioning unit 40 with the blow-out opening 41a that blows out cold air, and the side face outlet 50 that blows out cold air from the blow-out opening 41a.

The vehicle HUD 1 includes the light source 10 that emits display light and the optical path housing 20 that defines the optical path 21 through which the display light travels from the light source 10 to the head-up display 1. The vehicle HUD 1 displays information on the front windshield 3 by applying the display light that has passed through the optical path 21 to the front windshield 3.

The vehicle HUD 1 includes an air-conditioning duct 30 that defines the air flow path 31 that guides the cold air from the blow-out opening 41a to the side face outlet 50. At least a part of the light source 10 is exposed to the air flow path 31 of the air-conditioning duct 30 so that the light source 10 radiates heat to the cold air in the air flow path 31. Thus, the light source 10 is cooled by the cold air flowing through the air flow path 31. The optical path housing 20 and the air-conditioning duct 30 commonly includes the separation wall 32 that separate the air flow path 31 and the optical path 21.

Accordingly, a gap between the optical path housing 20 and the air-conditioning duct 30 can be eliminated. For this reason, as compared with the case where the optical path housing 20 and the air-conditioning duct 30 are formed independently, the total size of the optical path housing 20 and the air-conditioning duct 30 can be reduced. Therefore, it is possible to improve mountability of the optical path housing 20 and the air-conditioning duct 30 in a vehicle while keeping cooling capacity to cool the light source 10.

In the present embodiment, the air-conditioning duct 30 is a duct in which the air flow path 31 is not divided. For this reason, the air-conditioning duct 30 of this embodiment can make its size smaller as compared with a branch duct having a branch path. Therefore, mountability of the optical path housing 20 and the air-conditioning duct 30 in a vehicle can be further improved.

In the present embodiment, the light source 10 is exposed to the air flow path 31 of the air-conditioning duct 30 and the light source 10 is directly cooled by the cold air in the air flow path 31. Thus, cooling performance to the light source 10 can be improved. Therefore, the light source 10 with a high temperature state can be cooled for a short time. As a result, it is possible to shorten a time period for protecting electronic circuits of the light source 10 during which light emission by the light source 10 is limited when the light source 10 has a high temperature. Therefore, the brightness of the light source 10 at a high temperature can be improved.

In the present embodiment, since the light source 10 is directly cooled by the cold air in the air flow path 31 as described above, a cooling member (specifically, a Peltier element) to cool the light source 10 and a heat radiation fin to promote heat radiation of the light source 10 are not used. Thus, the cooling mechanism to cool the light source 10 can be further simplified.

In the above-stated comparative example, a branch duct is used as an air-conditioning duct. Furthermore, accessories such as a door and an actuator to selectively open and close the branch flow path for cooling the radiation portion of a light source are used.

On the other hand, the air-conditioning duct 30 of the present embodiment is a duct in which the air flow path 31 is not divided. Thus, accessories such as a door and an actuator to selectively open and close the branch flow path are not necessary. Therefore, an accessory attached to the air-conditioning duct 30 is also simplified, and thus a cost increase can be avoided in advance.

### Second Embodiment

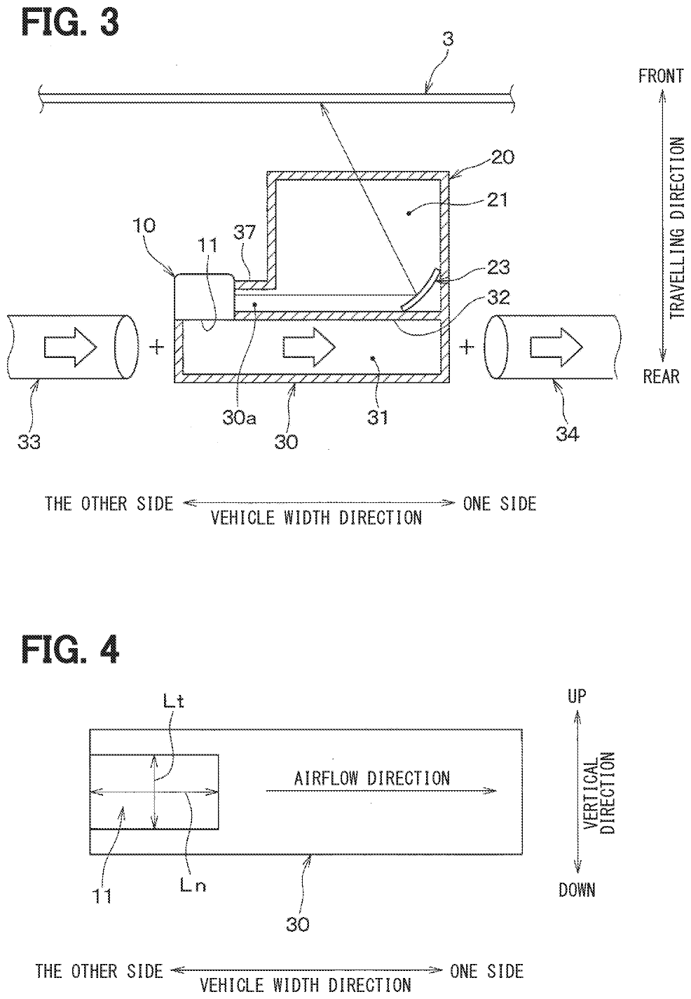

In the first embodiment, an example where the light source 10 is disposed on the rear side, and close to, the optical path housing 20 in the vehicle traveling direction has been presented. Instead, in the second embodiment, the light source 10 and the optical path housing 20 are arranged adjacent to each other along the vehicle width direction as showing in FIG. 3.

FIG. 3 is a perspective view of the vehicle HUD 1 of the present embodiment as viewed through the instrument panel 2 from an upper side. In FIG. 3, the same reference numerals as those in FIG. 1 denote the same components, and a description of the same components will be omitted.

The main difference between this embodiment and the first embodiment is the location of the light source 10. Hereafter, the location of the light source 10 which is the main difference is described, and other points will be simply described.

In the present embodiment, the light source 10 is disposed on the other side of the optical path housing 20 in the vehicle traveling direction. More specifically, the light source 10 is disposed next to the air-conditioning duct 30. Here, the other side in the vehicle width direction means one of the right side and the left side in the vehicle width direction on which the passenger seat is disposed.

Between the light source 10 and the optical path housing 20 of the present embodiment, a light guide tube 37 is disposed as in the first embodiment. Thus, a light guide path 30a for guiding display light from the light source 10 to the optical path 21 in the optical path housing 20 is formed between the light source 10 and the optical path housing 20. Although not shown, the optical path housing 20 of the present embodiment includes a window 22a disposed in the opening 22 as with the first embodiment.

Here, the light source 10 is located on the front side of the air-conditioning duct 30 in the vehicle traveling direction. The air-conditioning duct 30 is arranged on the rear side of the light source 10 and the optical path housing 20 in the vehicle traveling direction.

The light source 10 includes a heat radiating portion 11 that radiates heat generated from a display unit, a light emitting element, a drive circuit, and the like. The heat radiating portion 11 is disposed on the rear side of the light source 10 in the vehicle traveling direction. The heat radiating portion 11 constitutes a heat radiating surface exposed in the air flow path 31 of the air-conditioning duct 30. The heat radiating portion 11 defines the air flow path 31 together with the air-conditioning duct 30.

FIG. 4 shows an positional relationship between the thermal radiation part 11 and the air-conditioning duct 30 of this embodiment when viewed from a rear side of the vehicle traveling direction.

A direction along which the mainstream of air flow flowing through the air flow path 31 of the air-conditioning duct 30 is defined as an airflow direction. A particular direction which is orthogonal to the air flow direction and which is determined in advance is defined as an orthogonal direction. The mainstream means an air flow having the largest air volume among a plurality of air flows in the air-conditioning duct 30.

Here, the heat radiating portion 11 constitutes a heat radiating surface that extends across the air flow direction and the orthogonal direction. The largest dimension along the air flow direction in the heat radiating portion 11 is defined as a length Ln. The largest dimension along the orthogonal direction in the heat radiating portion 11 is defined as a length Lt.

The air flow direction of the present embodiment is in parallel with the vehicle width direction, and the orthogonal direction is in parallel with the vertical direction of the vehicle.

The heat radiating portion 11 is formed such that the length Ln is larger than the length Lt. Therefore, the heat radiation area of the heat radiating portion 11 can be enlarged.

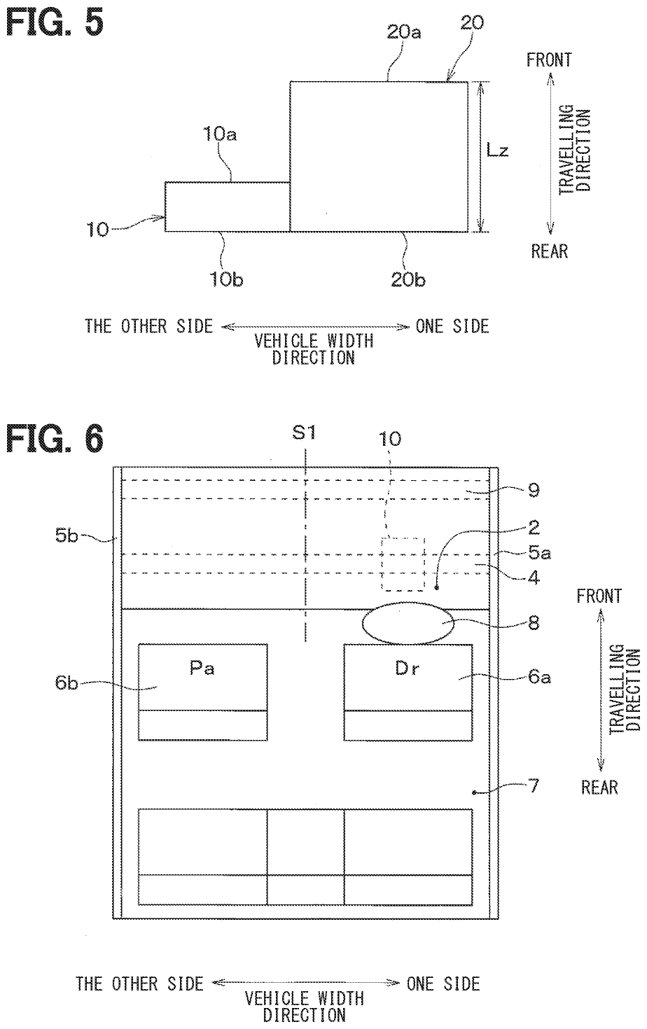

FIG. 5 shows a positional relationship between the light source 10 and the optical path housing 20 of this embodiment when viewed from an upper side.

An end portion of the optical path housing 20 located on a most front side in the vehicle traveling direction is referred to as a front end 20a, and an end portion of the optical path housing 20 located on a most rear side in the vehicle traveling direction is referred to as a rear end 20b. An end portion of the light source 10 located on a most front side in the vehicle traveling direction is referred to as a front end 10a, and an end portion of the light source 10 located on a most rear side in the vehicle traveling direction is referred to as a rear end 10b.

The front end 10a of the light source 10 is disposed behind the front end 20a of the optical path housing 20 in the vehicle traveling direction. The rear end 10b of the light source 10 is disposed at the same position as the rear end 20b of the optical path housing 20 in the vehicle traveling direction.

The light source 10 is fixed to a reinforcement 4 as shown in FIG. 6. As a result, the light source 10 is supported by the reinforcement 4. The reinforcement 4 is a beam member made of a metal material and formed to extend in the vehicle width direction.

The reinforcement 4 is disposed under the instrument panel 2 in the vertical direction. The reinforcement 4 is disposed behind a firewall 9 in the vehicle traveling direction and in front of the steering 8, the driver's seat 6a, and the passenger seat 6b in the vehicle traveling direction. The firewall 9 is a wall that separates an engine compartment from the vehicle interior 7.

The right end of the reinforcement 4 located on the right side of the center position S1 in the vehicle width direction is fixed to the chassis 5a of the vehicle. The chassis 5a is disposed on the right side of the center portion S1 in the vehicle width direction. The left end of the reinforcement 4 located on the left side of the center position S1 in the vehicle width direction is fixed to the chassis 5b of the vehicle.

The chassis 5b is disposed on the left side of the center portion S1 in the vehicle width direction. Each of the chassis 5a and 5b constitutes a framework of the vehicle. Thus, the reinforcement 4 plays a role of reinforcing the chassis 5a and 5b.

The air-conditioning duct 30 of the present embodiment is a duct in which the air flow path 31 is not divided as with the first embodiment. The air-conditioning duct 30 and the optical path housing 20 of the present embodiment commonly includes a separation wall 32 that separates the air flow path 31 and the optical path 21 as with the first embodiment.

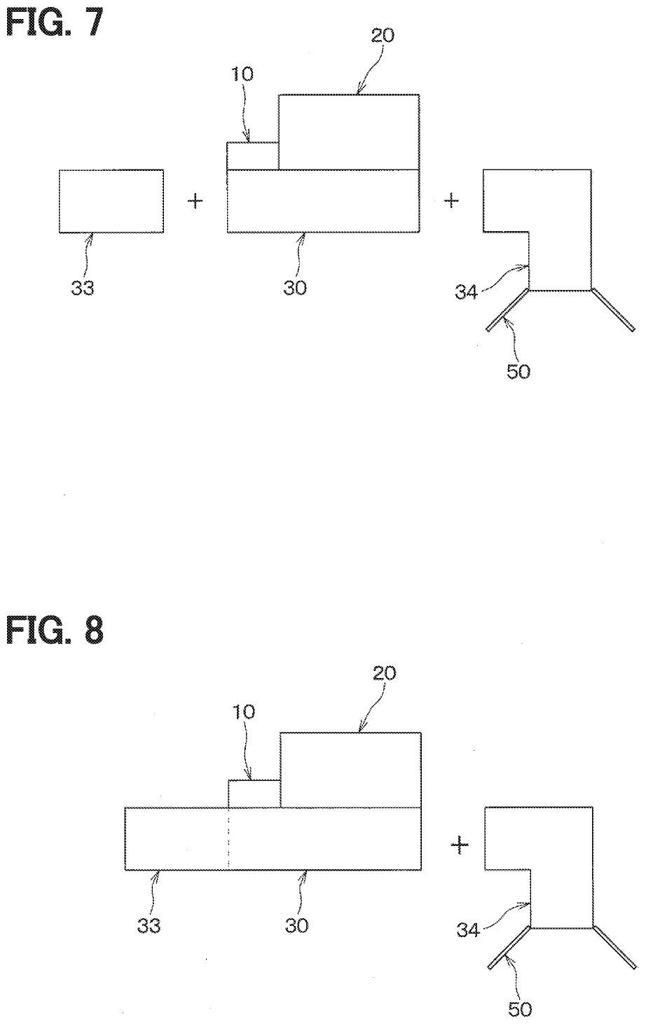

FIG. 7 is a diagram illustrating a connection relationship between the air-conditioning ducts 30, 33, and 34 according to the second embodiment. As shown in FIG. 7, an air-conditioning duct 33 is disposed between the air inlet of the air-conditioning duct 30 and the blow-out opening 41a of the vehicle air-conditioning unit 40 according to the present embodiment as with the first embodiment. The air inlet of the air-conditioning duct 33 is connected to the blow-out opening 41a. The air outlet of the air-conditioning duct 33 is connected to the air inlet of the air-conditioning duct 30.

The air-conditioning duct 34 is disposed between the air outlet of the air-conditioning duct 30 and the side face outlet 50 as with the first embodiment. The air outlet of the air-conditioning duct 30 is connected to the air inlet of the air-conditioning duct 34. The air inlet of the air-conditioning duct 34 is connected to the side face outlet 50.

Next, the operation of the vehicle head-up display 1 of this embodiment will be described.

Display light emitted from the light source 10 travels to the optical path 21 through the light guide path 30a. This display light travels in the optical path 21. At this time, the display light is reflected by the reflecting mirror 23, and the reflected display light passes through the window 22a and the opening 2a. The passed display light reaches the front windshield 3. As a result, various information based on the display light is displayed on the front windshield 3.

At this time, the light source 10 generates heat when emitting the display light. The heat radiating portion 11 of the light source 10 of the present embodiment is exposed to the air flow path 31 of the air-conditioning duct 30. Thus, the light source 10 radiates heat from the heat radiating portion 11 to the cold air in the air flow path 31. Thereby, the heat radiating portion 11 of the light source 10 is directly cooled by the cold air.

According to this embodiment described above, the heat radiating portion 11 of the light source 10 is exposed to the air flow path 31 of the air-conditioning duct 30 and the heat radiating portion 11 of the light source 10 radiates heat to the cold air in the air flow path 31. Thereby, the light source 10 is cooled by the cold air. In addition, the optical path housing 20 and the air-conditioning duct 30 commonly include the separation wall 32 that separate the air flow path 31 and the optical path 21.

Similar to the first embodiment, as compared with the case where the optical path housing 20 and the air-conditioning duct 30 are formed independently, the total size of the optical path housing 20 and the air-conditioning duct 30 can be small. Therefore, it is possible to improve mountability of the optical path housing 20 and the air-conditioning duct 30 in a vehicle while keeping cooling capacity of cooling the light source 10.

In the present embodiment, the air-conditioning duct 30 is a duct without a branch path which divides the cool air from the blow-out opening 41a as with the first embodiment. For this reason, since the size of the air-conditioning duct 30 can be reduced, the mountability of the optical path housing 20 and the air-conditioning duct 30 in an vehicle can be further improved.

The heat radiating portion 11 is formed such that the length Ln (see FIG. 4) is larger than the length Lt. Therefore, the heat radiation area of the heat radiating portion 11 can be enlarged. Thus, the cooling performance to the light source 10 can be further improved.

In the present embodiment, the light source 10 is disposed on the other side of the optical path housing 20 in the vehicle traveling direction. The light source 10 is disposed next to the optical path housing 20. Thereby, as compared with the case where the optical path housing 20 and the light source 10 are spaced apart from each other in the vehicle width direction, the total size of the optical path housing 20 and the light source 10 in the vehicle width direction can be reduced.

In the present embodiment, the front end 10a of the light source 10 is disposed behind the front end 20a of the optical path housing 20 in the vehicle traveling direction. Thereby, as compared with the case where the front end 10a of the light source 10 is located in front of the front end 20a of the light path housing 20 in the vehicle traveling direction, the length Lz along the vehicle traveling direction in the total size of the light path housing 20 and the light source 10 can be reduced.

In the present embodiment, the rear end 10b of the light source 10 is disposed at the same position as the rear end 20b of the optical path housing 20 in the vehicle traveling direction. Thereby, as compared with the case where the rear end 10b of the light source 10 is located behind the rear end 20b of the light path housing 20 in the vehicle traveling direction, the length Lz along the vehicle traveling direction in the total size of the light path housing 20 and the light source 10 can be reduced.

(Modifications) FIG. 8 is a diagram illustrating a connection relationship between air-conditioning ducts 30, 33, and 34 according to a modification to the second embodiment. In the second embodiment, the example in which the air-conditioning ducts 30, 33, and 34 are independently formed has been described. Instead, as shown in FIG. 8, the air-conditioning ducts 30, 33 are used as an integrally molded product.

In this case, the air inlet of the air-conditioning duct 33 is connected to the blow-out opening 41a of the vehicle air-conditioning unit 40. The air outlet of the air-conditioning duct 30 is connected to the air inlet of the air-conditioning duct 34. The air inlet of the air-conditioning duct 34 is connected to the side face outlet 50.

Furthermore, in the second embodiment, air-conditioning ducts 30 and 34 may be formed as an integrally molded product.

### Third Embodiment

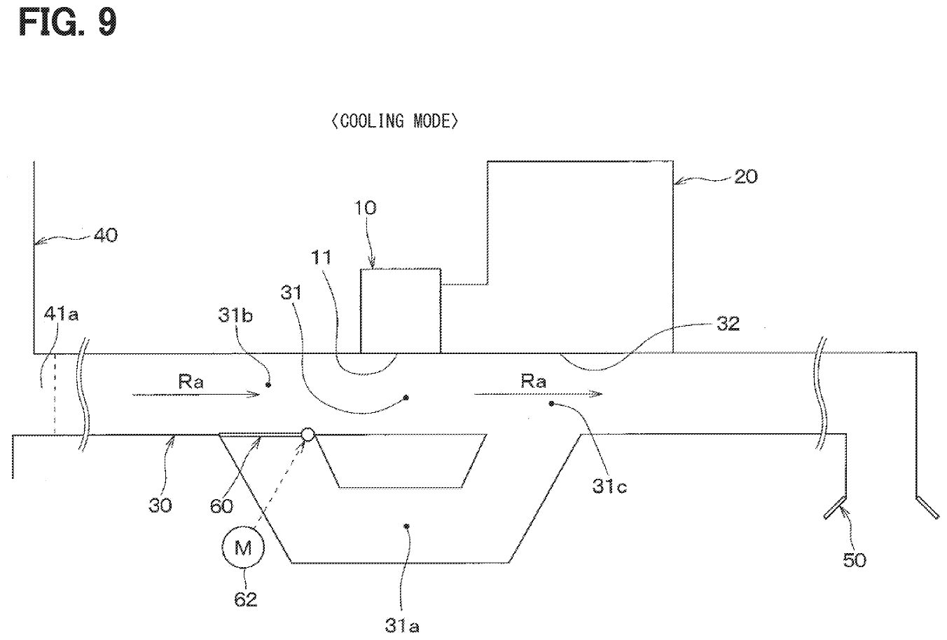

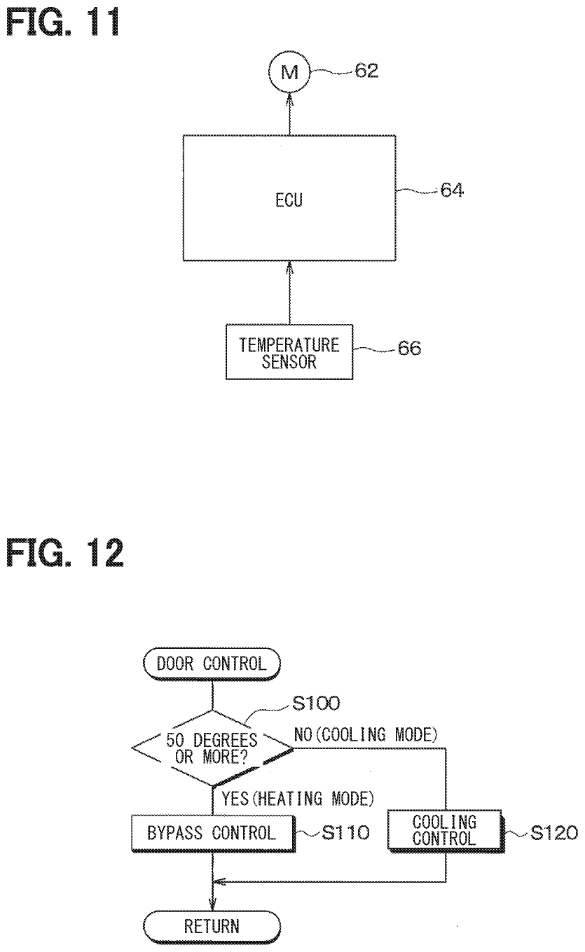

In the third embodiment, an example in which a bypass flow path 31a that causes air flow from the blow-out opening 41a of the vehicle air-conditioning unit 40 to bypass the heat radiating portion 11 is added in the first embodiment will be described with reference to FIGS. 9 to 12.

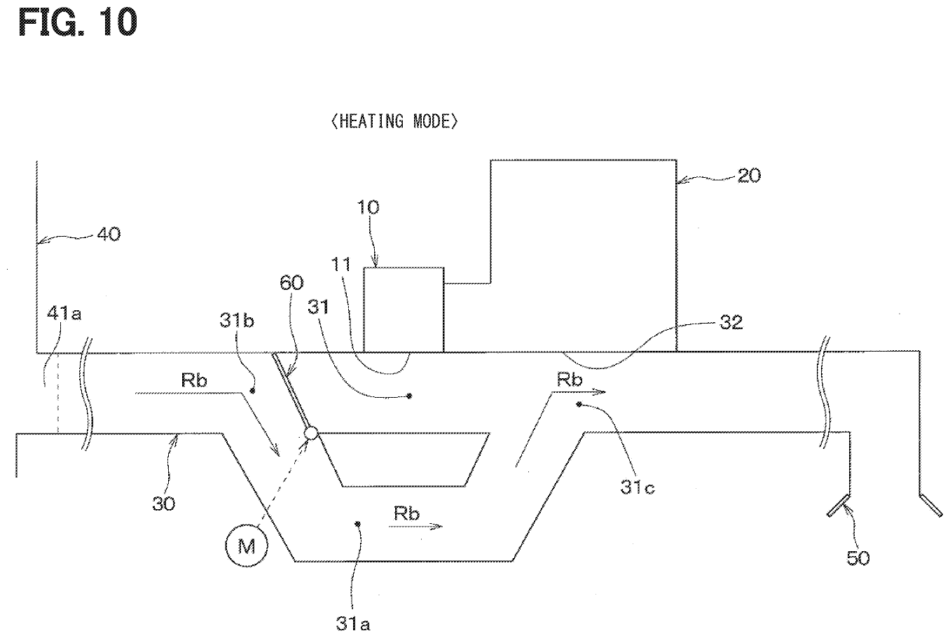

In this embodiment, a bypass flow path 31a and a door 60 are added to the vehicle HUD 1 of the first embodiment. In FIGS. 9 and 10, the same reference numerals as those in FIGS. 1 and 2 denote the same components, and a description of the same components will be omitted.

The bypass flow path 31a of the present embodiment is defined in the air-conditioning duct 30. The bypass flow path 31a is an air flow path for guiding the air flow blown from the blow-out opening 41a of the vehicle air-conditioning unit 40 to the side face outlet 50 by bypassing the heat radiating portion 11.

Specifically, the air-conditioning duct 30 is provided with a branching portion 31b that splits the air flow from the blow-out opening 41a of the vehicle air-conditioning unit 40 into the air flow path 31 and the bypass flow path 31a.

The air flow path 31 is an air flow path for guiding the air flow blown from the blow-out opening 41a of the vehicle air-conditioning unit 40 to the heat radiating portion 11.

Further, a merging portion 31c that merges the air flow that has passed through the air flow path 31 and the air flow that has passed through the bypass flow path 31a is formed at a position downstream of the heat radiating portion 11 in the air flow direction the air-conditioning duct 30.

The branch portion 31b of the air-conditioning duct 30 of the present embodiment has a door 60 that adjusts the ratio of the air volume flowing from the blow-out opening 41a to the air flow path 31 to the air flow flowing from the blow-out opening 41a to the bypass flow path 31a.

The door 60 is rotatably supported with respect to the air-conditioning duct 30 and closes one of the air flow path 31 and the bypass flow path 31a and opens the other. The door 60 is rotationally driven by an electric actuator 62.

As an electric actuator 62, various electric actuators such as a DC motor, an AC motor, and a stepping motor can be used.

The electric actuator 62 is controlled by an electronic control unit (ECU) 64. The ECU 64 includes a microprocessor, a memory, and the like. The ECU 64 executes an door control process in accordance with computer programs stored in advance in the memory. The memory is a non-transitory tangible storage medium.

The ECU 64 controls the door 60 via the electric actuator 62 based on the temperature detected by a temperature sensor 66 during the door control process. The temperature sensor 66 is a temperature sensor that detects a temperature of the air flow that is blown from the blow-out opening 41a of the vehicle air-conditioning unit 40.

The temperature sensor 66 of the present embodiment is disposed close to the blow-out opening 41a in the air-conditioning duct 30.

Next, the operation of the vehicle HUD 1 of the present embodiment will be described with reference to FIGS. 9, 10 and 12.

FIG. 12 is a flowchart showing details of the door control process executed by the ECU 64.

The ECU 64 executes the door control process according to a flowchart of FIG. 12. The door control process is repeatedly executed by the electronic control device 64.

Initially, at step S100, the ECU 64 determines whether the temperature of the air flow blown from the blow-out opening 41a of the vehicle air-conditioning unit 40 is equal to or higher than a threshold value (for example, 50° C.) based on the temperature detected by the temperature sensor 66.

When the temperature of the air flow blown from the blow-out opening 41a of the vehicle air-conditioning unit 40 is equal to or higher than the threshold value, the ECU 64 determines “YES” at step S100.

Accordingly, the ECU 64 controls the door 60 via the electric actuator 62 to execute a heating mode. Thus, the air flow path 31 is fully closed by the door 60, whereas the bypass flow path 31a is fully opened by the door 60 (see FIG. 10).

As a result, the amount of air flowing from the blow-out opening 41a of the vehicle air-conditioning unit 40 to the bypass passage 31a can be increased.

Specifically, it is possible to prevent the high-temperature air flow from the blow-out opening 41a of the vehicle air-conditioning unit 40 from directly flowing through the heat radiating portion 11. In addition to this, all of the high-temperature air flows blown out from the blow-out opening 41a pass through the branch portion 31b, the bypass channel 31a, and the merging portion 31c as shown by an arrow Rb in FIG. 10.

Therefore, it is possible to prevent the light source 10 from being obstructed by the high-temperature air flow blown from the blow-out opening 41a of the vehicle air-conditioning unit 40, thereby prevent the light source 10 from being hindered.

When the temperature of the air flow blown from the blow-out opening 41a of the vehicle air-conditioning unit 40 is lower than the threshold value, the ECU 64 determines “NO” at step S100.

Accordingly, the ECU 64 controls the door 60 via the electric actuator 62 to execute a cooling mode. Thus, the air flow path 31 is fully opened by the door 60, whereas the bypass flow path 31a is fully closed by the door 60 (see FIG. 9).

As a result, the amount of air flowing from the blow-out opening 41a of the vehicle air-conditioning unit 40 to the heat radiating portion can be increased

Specifically, it is possible to prevent the low-temperature air flow from the blow-out opening 41a of the vehicle air-conditioning unit 40 from flowing into the heat radiating portion 11. In addition to this, the low-temperature air flow blown out from the blow-out opening 41a flows toward the side face outlet 50 through the air flow path 31 as shown by an arrow Ra in FIG. 9.

Thus, the air flow blown out from the blow-out opening 41a of the vehicle air-conditioning unit 40 flows to the heat radiating portion 11. Therefore, the heat radiating portion 11 can be radiated effectively by the air flow blown from the blow-out opening 41a of the vehicle air-conditioning unit 40.

According to the present embodiment described above, in the vehicle HUD 1, the air-conditioning duct 30 has the bypass flow path 31a that causes the air flow from the blow-out opening 41 to bypass the heat radiating portion 11.

The door 60 adjusts the ratio of the amount of air flowing from the blow-out opening 41a toward the heat radiating portion 11 through the air channel to the amount of air flowing from the blow-out opening 41a to the bypass channel 31a.

When the ECU 64 determines that the temperature of the air flow from the blow-out opening 41a is equal to or higher than the threshold value, the ECU 64 controls the door 69 via the electric actuator 62 as follows.

That is, the ECU 64 fully closes the air flow path 31 by the door 60 and fully opens the bypass flow path 31a by the door 60.

As a result, the amount of air flowing from the blow-out opening 41a to the bypass passage 31a is greater than the amount of air flowing from the blow-out opening 41a toward the heat radiating portion 11. Thus, it is possible to restrict the high temperature air flow from flowing through the heat radiating portion 11.

For this reason, it is possible to prevent interference with heat radiation by the light source 10 by the high-temperature air flow, thereby preventing the light source 10 from being hindered. That is, it is possible to prevent malfunction in the light source 10 from occurring in advance.

On the contrary, when the ECU 64 determines that the temperature of the air flow from the blow-out opening 41a is lower than the threshold value, the ECU 64 controls the door 69 via the electric actuator 62 as follows.

That is, the ECU 64 fully opens the air flow path 31 by the door 60 and fully closes the bypass flow path 31a by the door 60.

As a result, the amount of air flowing from the blow-out opening 41a toward the heat radiating portion 11 is greater than the amount of air flowing from the blow-out opening 41a to the bypass passage 31a. For this reason, since a large amount of low-temperature air flows can be supplied to the heat radiating portion 11, a large amount of heat can be released at the heat radiating portion 11 to the air flow.

As described above, the door 60 can be appropriately controlled via the electric actuator 62 based on the temperature of the air flow from the blow-out opening 41a. Therefore, it is possible to prevent malfunction in the light source 10 from occurring while obtaining efficient heat radiation from the light source 10 through the heat radiating portion 11.

### Other Embodiments

(1) In the first, second, and third embodiments and the modifications described above, the head-up display 1 that displays information on the front windshield 3 has been described. However, the present disclosure is not limited thereto, and a head-up display 1 that displays information on a side windshield may be used. Alternatively, a head-up display 1 that displays information on a rear windshield may be used.

(2) In the first, second, and third embodiments and the modifications described above, the head-up display 1 is applied to an automotive. Alternatively, the head-up display 1 may be applied to any type of moving bodies other than automotive, such as airplanes, trains, electric trains, ships, and so on.

(3) In the first, second, and third embodiments and the modifications described above, the side face outlet 50 that blows out cold air into the vehicle interior is used as the air outlet that blows out cold air after it passed through the air-conditioning duct 30. Instead, the following alternatives (a) and (b) may be used.

(a) A blower outlet that blows out cold air into the vehicle interior is used as an air outlet that blows out cold air that has passed through the air-conditioning duct 30.

(b) As the air outlet for blowing out the cold air that has passed through the air-conditioning duct 30, a face outlet, a foot outlet, or a defroster outlet other than the side face outlet may be used.

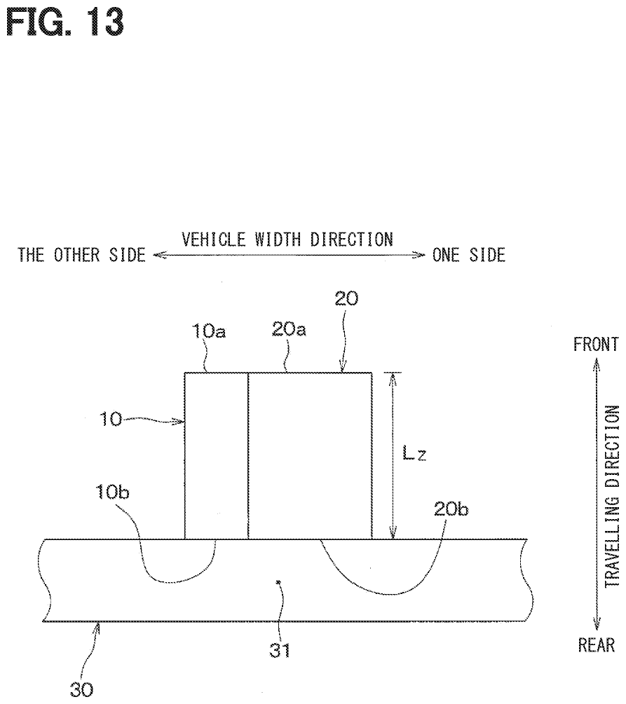

(4) In the second embodiment and the modifications described above, the front end 10a of the light source 10 is located behind the front end 20a of the optical path housing 20 in the vehicle traveling direction. However, the present disclosure is not limited thereto, and the front end 10a of the light source 10 may be disposed at the same position as the front end 20a of the optical path housing 20 in the vehicle traveling direction (see FIG. 13).

Furthermore, in the second embodiment and the modification, the rear end 10b of the light source 10 is disposed at the same position as the rear end 20b of the optical path housing 20 in the vehicle travelling direction. However, the present disclosure is not limited thereto, and the rear end 10b of the light source 10 may be disposed in front of the rear end 20b of the optical path housing 20 in the vehicle traveling direction.

Accordingly, the length Lz along the vehicle traveling direction of the optical path housing 20 and the light source 10 can be reduced.

(5) In the second embodiment and the modification, the light source 10 is disposed on the other side of the optical path housing 20 in the vehicle width direction. Instead, the light source 10 may be disposed on the one side of the optical path housing 20 in the vehicle width direction.

(6) In the first, second, and third embodiments and the modifications described above, the single reflecting mirror 23 is used to guide the display light from the light source 10 toward the front windshield 3. However, a plurality of reflecting mirrors 23 may be arranged in the optical path housing 20 to guide the display light from the light source 10 toward the front windshield 3.

(7) In the first, second, and third embodiments and the modifications described above, the cooling member for cooling the light source 10 and the radiating fin for promoting heat radiation at the light source 10 are not used. Alternatively, a cooling member and a radiating fin may be used.

(8) In the first, second, and third embodiments and the modifications described above, the light source 10 and the optical path housing 20 are positioned offset from each other. Alternatively, a portion of the light source 10 may be covered by the optical path housing 20.

(9) In the first, second, and third embodiments and the modifications, the cold air flows through the air flow path 31 of the air-conditioning duct 30 and the light source 10 is cooled by this cold air. However, the following alternatives may be used. That is, an inside air and/or outside air may flow through the air flow path 31 of the air-conditioning duct 30 without adjusting their temperature, and the light source 10 may be cooled by the inside and/or outside air.

(10) In the third embodiment, when the temperature of the air flow from the blow-out opening 41a of the vehicle air-conditioning unit 40 is equal to or higher than the threshold value, the air flow path 31 is fully closed by the door 60, and the bypass channel 31a is fully opened by 60.

However, the present disclosure is not limited to this, and when the amount of air flowing from the blow-out opening 41a to the bypass passage 31a is greater than the amount of air flowing from the blow-out opening 41a to the heat radiating portion 11, the air passage 31 may be slightly opened by the door 60.

Furthermore, when the temperature of the air flow from the blow-out opening 41a of the vehicle air-conditioning unit 40 is lower than the threshold value, the air flow path 31 is fully opened by the door 60, and the bypass channel 31a is fully closed by 60.

However, the present disclosure is not limited to this, and when the air flow flowing from the blow-out opening 41a to the heat radiating portion 11 is greater than the air flow flowing from the blow-out opening 41a to the bypass flow path 31a, the bypass flow path 31a may be slightly opened by the door 60.

(11) In the third embodiment, the temperature sensor 66 is used to detect a temperature of the air flow blown from the blow-out opening 41a of the vehicle air-conditioning unit 40. However, the following alternatives (c) and (d) may be used.

(c) The temperature of the air flown from the blow-out opening 41a may be calculated based on a target blowing air temperature TAO used for controlling the blowing air temperature in the vehicle air-conditioning unit 40.

(d) Without using the temperature sensor 66, a temperature of the air flow blown from the blow-out opening 41a of the vehicle air-conditioning unit 40 may be estimated based on a detection value of an inside air temperature sensor that detects a temperature in the vehicle interior or based on various information such as a set temperature of the vehicle interior. The estimated temperature of the air flow may be used for the determination process at step S100.

(12) In the third embodiment, 50° C. is used as the threshold value that is used in the determination process of the temperature of the air flow blown from the blow-out opening 41a of the vehicle air-conditioning unit 40 at step S100. Instead, a temperature other than 50° C. may be used as the threshold value.

(13) It should be noted that the present disclosure is not limited to the above-described embodiments, and can be modified as appropriate. The above embodiments are not independent of one another but can be combined as appropriate unless clearly not combinable. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Also, the shape, the positional relationship, and the like of the component or the like mentioned in the above embodiments are not limited to those being mentioned unless otherwise specified, limited to the specific shape, positional relationship, and the like in principle, or the like.

(Overview)

According to a first aspect described in part or all of the first, second, and third embodiments, and the other embodiments, a head-up display for a moving body that includes a windshield, an air-conditioning unit having a blow-out opening through which an air flow is blown out, and an air outlet blowing out the air flow from the blow-out opening.

The head-up display includes a light source that emits display light for displaying information, and an optical path housing that forms an optical path for the display light to travel from the light source to the windshield, wherein the display light that has passed through the optical path is applied to the windshield and the information is displayed on the windshield.

The head-up display further includes an air-conditioning duct that defines an air flow path along which the air flow from the blow-out opening to the air outlet, wherein the light source is disposed in the air flow path of the air-conditioning duct and radiates heat into the air flow path, and the optical path housing and the air-conditioning duct commonly includes a separation wall that separates the air flow path and the optical path.

According to a second aspect, the light source is disposed next to the optical path housing.

Here, a direction in which the light source and the optical path housing are arranged is defined as an arrangement direction. As compared with the case where a light source and an optical path housing are arranged mutually apart from each other, the length along the arrangement direction of the light source and the optical path housing can be reduced.

According to a third aspect, the light source includes a heat radiating portion that is exposed in the air flow path and radiates heat in the air flow path. A direction along which a mainstream of the air flow flows through the air flow path is defined as an air flow direction, and a direction that is orthogonal to the air flow direction and that is determined in advance is defined an orthogonal direction.

The heat radiating portion extends along both the air flow direction and the orthogonal direction. A largest dimension of the heat radiating portion in the air flow direction is defined as a first length, a largest dimension of the heat radiating portion in the orthogonal direction is defined as a second length, and the heat radiating portion is formed such that the first length is greater than the second length.

Thereby, as compared with the case where the second length is greater than the first length, the heat radiation area of the heat radiating portion can be enlarged.

According to a fourth aspect, the light source, the optical path housing, and the air-conditioning duct are mounted in a vehicle as the moving body.

According to a fifth aspect, the optical path housing and the light source are arranged along the vehicle width direction.

An end portion of the optical path housing located on a most front side in the vehicle traveling direction is referred to as a front end, and an end portion of the optical path housing located on a most rear side in the vehicle traveling direction is referred to as a rear end.

An end portion of the light source located on a most front side in the vehicle traveling direction is referred to as a front end, and an end portion of the light source located on a most rear side in the vehicle traveling direction is referred to as a rear end.

The front end of the light source is located in the vehicle traveling direction at the same position as the front end of the optical path housing or behind the front end of the optical path housing.

The rear end of the light source is located in the vehicle traveling direction at the same position as the rear end of the optical path housing or in front of the rear end of the optical path housing.

Thereby, as compared with the case where the front end of the light source is located in front of the front end of the light path housing in the vehicle traveling direction, the length along the vehicle traveling direction in the size of the light path housing and the light source can be reduced.

According to a sixth aspect, the air outlet blows out the air flow into a vehicle interior. According to a seventh aspect, the air outlet is a side face outlet that is disposed on the right side or the left side of a center of the vehicle width direction in the vehicle interior and blows the air flow toward the occupant upper body.

According to an eighth aspect, the head-up display is applied to a vehicle including a downstream duct that guides an air flow blown from an air-conditioning duct to an air outlet, and the air outlet of the air-conditioning duct is connected to the air inlet of the downstream duct.

According to a ninth aspect, the head-up display is applied to a vehicle including a upstream duct for guiding the air flow from the air blow-out opening of the air-conditioning unit to the air-conditioning duct. The air-conditioning duct has an air inlet that is connected to the air outlet of the downstream duct.

According to a tenth aspect, the head-up display is applied to a vehicle including a chassis and a reinforcement, the reinforcement extending along a vehicle width direction and having a left side portion on the left side of a center position of the vehicle width direction and a right side portion on the right side of the center position of the vehicle width direction, the left side portion and the right side portion connected to the chassis. The light source is supported by the reinforcement.

According to an eleventh aspect, the optical path housing and the air-conditioning duct are integrally formed with each other.

According to an eleventh aspect, a door, a determination unit, a first control unit, and a second control unit are provided.

The air-conditioning duct defines a bypass channel that has the air flow from the blow-out opening bypass the heat radiating portion toward the air outlet.

The door adjusts the ratio of an amount of air flowing from the outlet opening toward the heat radiating portion to an amount of air flowing from the outlet opening to the bypass channel.

The determining unit is configured to determine whether a temperature of the air flow from the blow-out opening is equal to or higher than a threshold value.

The first control unit is configured to control the door so that an amount of the air flowing from the outlet opening to the bypass channel is greater than an amount of the air flowing from the outlet opening toward the heat radiating portion when the determining unit determines that the temperature of the air flow from the blow-out opening is equal to or higher than the threshold value.

The second control unit is configured to control the door so that an amount of the air flowing from the outlet opening toward the heat radiating portion is greater than an amount of the air flowing from the outlet opening to the bypass channel when the determining unit determines that the temperature of the air flow from the blow-out opening is less than a threshold value.

Therefore, when the temperature of the air flow from the blow-out opening is equal to or higher than the threshold value, the air flow flowing from the blow-out opening to the bypass channel is more increased than the air flow flowing from the blow-out opening toward the heat radiating portion. Thus, since the high-temperature air flow can be restricted from flowing into the heat radiating portion, it is possible to prevent interference with heat radiation by the light source by the high-temperature air flow, thereby preventing the light source from being hindered.

On the other hand, when the temperature of the air flow from the blow-out opening is lower than the threshold value, the amount of air flowing from the blow-out opening to the heat radiating portion is more increased than the amount of air flowing from the blow-out opening to the bypass channel. Thus, a large amount of low-temperature air flows into the heat radiating portion, and therefore efficient heat radiation can be performed at the heat radiating portion.

1. A head-up display for a moving body that includes a windshield, an air-conditioning unit having a blow-out opening through which an air flow is blown out, and a blow-out outlet through which the air flow from the blow-out opening is blown out, the head-up display comprising:
a light source that emits display light for displaying information; and
an optical path housing that defines therein an optical path for the display light to travel from the light source to the windshield, wherein
the display light that has passed through the optical path reaches the windshield and the information is displayed on the windshield,
the head-up display further comprises an air-conditioning duct that defines therein an air flow path along which the air flow from the blow-out opening flows to the blow-out outlet, wherein
the light source is exposed to the air flow path of the air-conditioning duct and radiates heat in the air flow path,
the optical path housing and the air-conditioning duct commonly includes a separation wall that separates the air flow path and the optical path, and
the optical path housing and the air-conditioning duct are integrally formed with each other.

2. The head-up display according to claim 1, wherein
the light source is located next to the optical path housing.

3. The head-up display according to claim 1, wherein
the light source includes a heat radiating portion that is exposed to the air flow path and radiates heat in the air flow path,
a direction along which a mainstream of the air flow flows through the air flow path is defined as an air flow direction,
a direction that is orthogonal to the air flow direction is defined an orthogonal direction,
the heat radiating portion extends along both the air flow direction and the orthogonal direction,
a largest dimension of the heat radiating portion along the air flow direction is defined as a first length,
a largest dimension of the heat radiating portion along the orthogonal direction is defined as a second length, and
the heat radiating portion is formed such that the first length is greater than the second length.

4. The head-up display according to claim 1, wherein
the light source, the optical path housing, and the air-conditioning duct are mounted in a vehicle as the moving body.

5. The head-up display according to claim 4, wherein
the light source and the optical path housing are arranged along a vehicle width direction,
an end of the optical path housing that is located at a most front position in a vehicle traveling direction is defined as a front end,
an end of the optical path housing that is located at a most rear position in the vehicle traveling direction is defined as a rear end,
an end of the optical source that is located at a most front position in the vehicle traveling direction is defined as a front end,
an end of the optical source that is located at a most rear position in the vehicle traveling direction is defined as a rear end, wherein
the front end of the light source is located in the vehicle traveling direction at the same position as the front end of the optical path housing or behind the front end of the optical path housing, and
the rear end of the light source is located in the vehicle traveling direction at the same position as the rear end of the optical path housing or in front of the rear end of the optical path housing.

6. The head-up display according to claim 1, wherein
the blow-out outlet blows out the air flow into a vehicle interior.

7. The head-up display according to claim 6, wherein
the blow-out outlet is a side face outlet that is disposed on the right side or the left side of a center position of the vehicle interior in the vehicle width direction and blows out the air flow toward an occupant's upper body.

8. The head-up display according to claim 1, wherein
the moving body is a vehicle including a downstream duct for guiding the air flow blown out from the air-conditioning duct to the blow-out outlet, and
the air-conditioning duct has an air outlet that is connected to an air inlet of the downstream duct.

9. The head-up display according to claim 1, wherein
the moving body is a vehicle including a upstream duct for guiding the air flow from the air blow-out opening of the air-conditioning unit to the air-conditioning duct, and
the air-conditioning duct has an air inlet that is connected to an air outlet of the downstream duct.

10. The head-up display according to claim 1, wherein
the moving body is a vehicle including a chassis and a reinforcement that reinforces the chassis, the reinforcement extending along a vehicle width direction and having a left side portion on the left side of a center position of the vehicle in the vehicle width direction and a right side portion on the right side of the center position in the vehicle width direction, the left side portion and the right side portion connected to the chassis, and
the light source is supported by the reinforcement.

11. The head-up display according to claim 1, further comprises:
a door;
a determining unit;
a first control unit; and
a second control unit, wherein
the air-conditioning duct defines a bypass channel that causes the air flow from the blow-out opening to bypass the heat radiating portion and guides the air flow toward the blow-out outlet,
the door adjusts a ratio of an amount of air flowing from the blow-out opening toward the heat radiating portion to an amount of air flowing from the blow-out opening to the bypass channel,
the determining unit is configured to determine whether a temperature of the air flow from the blow-out opening is equal to or higher than a threshold value,
the first control unit is configured to control the door so that an amount of the air flowing from the blow-out opening to the bypass channel is greater than an amount of the air flowing from the blow-out opening toward the heat radiating portion when the determining unit determines that the temperature of the air flow from the blow-out opening is equal to or higher than the threshold value, and
the second control unit is configured to control the door so that an amount of the air flowing from the blow-out opening toward the heat radiating portion is greater than an amount of the air flowing from the blow-out opening to the bypass channel when the determining unit determines that the temperature of the air flow from the blow-out opening is less than the threshold value.

12. The head-up display according to claim 1, further comprises:
a door; and
an electronic control unit (ECU), wherein
the air-conditioning duct defines a bypass channel that has the air flow from the blow-out opening bypass the heat radiating portion and guides the air flow toward the air outlet,
the door adjusts a ratio of an amount of air flowing from the blow-out opening toward the heat radiating portion to an amount of air flowing from the blow-out opening to the bypass channel, and
the ECU is configured to:
determine whether a temperature of the air flow from the blow-out opening is equal to or higher than a threshold value;
control the door so that an amount of the air flowing from the blow-out opening to the bypass channel is greater than an amount of the air flowing from the blow-out opening toward the heat radiating portion upon determining that the temperature of the air flow from the blow-out opening is equal to or higher than the threshold value; and
control the door so that an amount of the air flowing from the blow-out opening toward the heat radiating portion is greater than an amount of the air flowing from the blow-out opening to the bypass channel upon determining that the temperature of the air flow from the blow-out opening is less than the threshold value.
